(19) United States
(12) Patent Application Publication
(10) Pub. No.: US 2013/0007662 A1
(43) Pub. Date: Jan. 3, 2013

(54) PRIORITIZATION OF URGENT TASKS ON MOBILE DEVICES

(75) Inventors: JUDITH H. BANK, MORRISVILLE, NC (US); LISA M. BRADLEY, CARY, NC (US); LIN SUN, MORRISVILLE, NC (US); CHUNHUI YANG, DURHAM, NC (US)

(73) Assignee: INTERNATIONAL BUSINESS MACHINES CORPORATION, ARMONK, NY (US)

(21) Appl. No.: 13/172,329

(22) Filed: Jun. 29, 2011

(51) Int. Cl. G06F 3/048

(52) U.S. Cl. 715/811

(57) ABSTRACT

Application launching icons are prioritized and displayed on a mobile electronic device having a limited display area. How much time is available to a user for use of the device is determined, and any tasks that correspond to defined priorities are identified. The application launching icons are prioritized for display order in accordance with time and priorities to provide the user with a prioritized arrangement of the applications as represented by the icons in order to accomplish priority tasks.

### BACKGROUND

The present invention relates, in general, to mobile computer devices, and in particular, to prioritizing the display on a mobile device to reflect priorities.

Computer technology, in both hardware and software, enables the use of small mobile devices, such as, mobile phones, personal digital assistants, and electronic tablets, to execute programs and applications that previously required a desktop/laptop computer. These mobile devices are very popular but are subject to certain constraints, such as, relatively small viewing screens. Applications installed on these devices are typically displayed as icons, and are typically launched by touching the screen. Due to the limited size of the visual display, it can often be difficult to locate the desired icon for the appropriate action.

### BRIEF SUMMARY

According to one embodiment of the present invention, a method prioritizes and displays application launching icons on a mobile electronic device having a limited display area. A processor is used to identify how much time is available to a user for use of the device. The processor identifies any tasks that correspond to defined priorities. The application launching icons are displayed in accordance with time and priorities in order to provide the user with a prioritized arrangement of the applications as represented by the icons in order to accomplish priority tasks.

According to one embodiment of the present invention, a system prioritizes and displays application launching icons on a mobile electronic device that has a limited display area. A memory, connected to a processor, is encoded with instructions. When the instructions are executed how much time available to a user for use of the device is identified. In addition, tasks that correspond to defined priorities are identified. As a result, the application launching icons are displayed in accordance with how much time is available and any defined priorities in order to provide the user with a prioritized arrangement of the applications as represented by the icons in order to accomplish priority tasks.

A computer program product prioritizes and displays application launching icons on a mobile electronic device having a limited display area. The computer program product comprises a computer readable storage medium having computer readable program code embodied therewith. Computer readable program code is configured to identify how much time is available to a user for use of the device. Computer readable program code is configured to identify any tasks that correspond to defined priorities. Computer readable program code is configured to display the application launching icons in accordance with how much time and any defined priorities in order to provide the user with a prioritized arrangement of the applications as represented by the icons in order to accomplish priority tasks.

### BRIEF DESCRIPTION OF THE SEVERAL VIEWS OF THE DRAWINGS

FIG. 1 is an illustration of a computer system which can implement the present invention; and

FIG. 2 is an illustration of a mobile network, upon which the present invention can be implemented;

FIG. 3 is a flow diagram illustrating an embodiment of the present invention;

FIG. 4 is a flow diagram illustrating determination of time constraints;

FIG. 5 is a flow diagram illustrating determination of any priorities; and

FIG. 6 illustrates a user control for adjusting available time.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

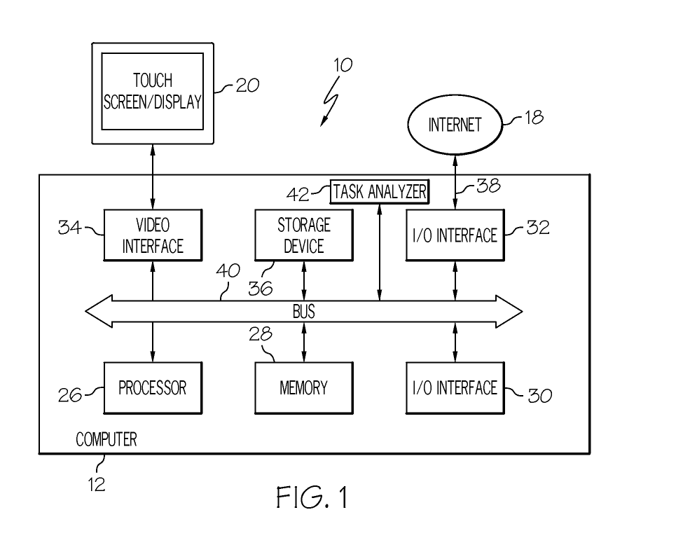

FIG. 1 is one example of a system 10 suitable for executing computer software for prioritizing urgent tasks and for sorting applications on mobile devices. Processing devices which are suitable for executing the software can be a wireless telephone, a personal assistant device (PDA), a portable computer, a smart remote control device, or any other processing devices that can execute such software.

The system 10 is of a type that executes under a suitable operating system installed thereon. The components of the system 10 include a computer 12, and a touch sensitive screen/display 20. The computer 12 includes a processor 26, a memory 28, input/output (I/O) interfaces 30 and 32, a video interface 34, a storage device 36, and a task analyzer 42.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to the touch sensitive screen/display 20 and provides video signals for display thereon. User input to operate the computer 12 is provided from the touch sensitive screen/display 20. The storage device 36 can include a subscriber identity module or subscriber identification module (SIM) or any other suitable storage medium, as discussed above. Each of the components of the computer 12 is connected to an internal bus 40 that includes data, address, and control buses, to allow components of the computer 12 to communicate with each other via the bus 40. The system 10 can be connected to one or more other similar computers via an input/output (I/O) interface 32 using a wireless communication channel 38 to a network, represented as the Internet 18. One or more servers (not shown) may be connected to the computer 12 via a network, such as, the Internet 18.

The computer software may be recorded on a computer readable storage medium, in which case, the computer software program is accessed by the system 10 from the storage device 36. Alternatively, the computer software can be accessed directly from the Internet 18 by the computer 12. In either case, a user can interact with the computer system 10 using the touch sensitive screen/display 20 to operate the programmed computer software executing on the computer 12.

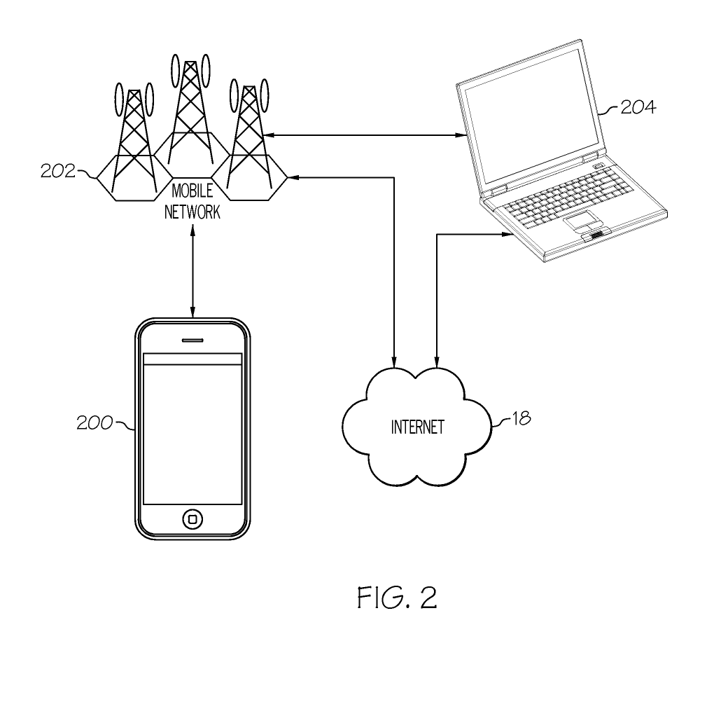

Referring to FIG. 2, a mobile communication network is illustrated. A mobile phone 200 is wirelessly connected to a mobile network 202 and the Internet 18. In addition, another mobile device, such as a laptop computer 204, may be connected to the Internet 18 and/or the mobile network 202.

Mobile devices are often used when a user is away from a desktop or laptop computer, as it is easier to carry mobile devices such as electronic tablets and cell phones while going about their daily activities. The result is that users do not, typically, stay at any given location for very long. Such activities are, for example, dining out, waiting in the car to pick up children, reading in a coffee shop, etc. Therefore, users may only have a limited amount of time to interact with their mobile devices. Within such a limited timeframe, they need to focus first on any urgent tasks that need their immediate attention. If there are no urgent tasks, they may next need to select applications that can be used in a short period of time. For example, if there are some urgent emails that the user is anticipating, it is important to identify and read these messages before doing anything casual, like continuing to read a book, checking the weather, or playing an electronic game. When there are many applications available on the mobile device, it is possible to have difficulty locating the icon representing the desired application.

When a user's social network connection and on-line status is available, it may change the user's decision on what application to use. For example, if user A has marked user B as “alert when active” and the system determines that user B is on line and logged into an instant messaging service, user A may want to chat with user B instead of checking email. In such situations, it is desirable to prioritize tasks and ‘todos’ for the user, and, thus, prioritize display of application icons on mobile devices giving preference to applications that he/she can use to finish his/her prioritized tasks.

In an embodiment of the present invention, an intelligent method analyzes items that need the user's immediate attention and, thus, alerts the user to those items. In addition, icons representing applications that can be used to finish the prioritized tasks within a specific timeframe on the mobile device are prioritized and more prominently displayed, thereon. If there aren't any items that need the user's immediate attention, the display of icons for applications can be based on the user's average usage duration history, user's settings of network preferences, user's social network on line status, user's time management, or user's contacts' current activities.

An embodiment of the present invention can be used to determine if there are any actions that need the user's immediate attention. When there are urgent items, such as email, arriving in an inbox of the user's computer 204, the email can be sent to the user's mobile phone 200 using Short Message Service (SMS). When there are anticipated items, like contacts that the user has marked as “alert me when available,” become available to chat, an SMS can also be sent to the mobile phone 200, to alert the user. Other anticipated items could be another bid to the user's existing bid on an auction website, an interesting item posted on a ‘for sale’ website, etc. These generated SMS messages can be prefixed with a keyword, such as, for example, “Analyzer” to differentiate from non-generated SMS messages. There will not be any user related alert for non-generated SMS messages since they are only used for the generated SMS messages.

A task analyzer 42 (FIG. 1), on the user's device (mobile device 200), analyzes the SMS messages to determine if the user needs to be alerted on the landing page. If it is determined that the user needs to be alerted, the user will be alerted on the landing page using, for example, a blinking mail icon, to indicate important email, a blinking instant messaging icon to indicate interesting person/messages, etc.

The applications on the mobile device 200 will then be prioritized and appropriately positioned, according to the applications that can be used to finish the tasks that need the user's immediate attention, and that can be done within a certain timeframe. Then the remaining applications are prioritized based on other criteria as discussed below.

The task analyzer 42 may use a software program that uses historical information about past application usage (for this user and device, updated after every use), specific preferences previously input by the user, and environmental information such as the user location, time of day, day of the week, recent alerts, etc., to determine the priority order for displaying icons or other objects which are used to launch applications on this device. For example, historical information indicates that when the user is downtown (using GPS to locate) on Saturday night at 7 PM, he selects a new movie and purchases tickets using the Fandango website (Fandango is a registered trademark of Fandango). The task analyzer 42 would detect that today is Saturday, the current time is 6:45 PM, and the user is located downtown. It is, therefore, likely the user would be interested in movie reviews. The analyzer thus classifies the icon for a movie review application to a high priority and proceeds to prominently display the review icon (as long as no urgent alerts had recently arrived). Also, the user may be interested in using Fandango to purchase tickets, and, thus, the web browser application with the link to Fandango could also be displayed to the user.

The following applies when there are no tasks that need a user's immediate attention. The intelligent priority sorting of icons requires that the mobile phone software maintain a history of the duration of application usage. This history is updated each time the user executes a phone application, such that an accurate average usage time is maintained for each application. This information can optionally be used as the primary priority criteria. An embodiment of the intelligent priority sorting of mobile applications includes, for example, the following criteria. A user can dynamically select which criteria he/she prefers to use at the current time. The user can also dynamically change the prioritizing criteria, and the application display will dynamically change the order of the icons on the mobile device screen:

A. User's settings of network preference:
A user can configure settings so that when a wifi network is not available, certain applications are prioritized into a group that needs more network data transmission time, such as GPS, browsing the internet, checking email, Youtube, etc. Some wireless or mobile phone plans only provide the user with a specific number of phone usage minutes or Internet bytes transmitted before additional fees apply. The user may choose to have the task analyzer consider usage charges, when displaying icons. For example, the user might not want to use the Internet at the end of the month when he is close to or over the limits specified in his monthly plan. Thus, applications requiring Internet down loads would be classified as low priority. The task analyzer could optionally consider the cost of using applications when assigning priority.

B. User's application usage statistics history:
The intelligent priority sorting of mobile device applications tracks the usage duration of each application use, so that each application can be prioritized in the order of the usage duration. For example, if a user is in a school car pool waiting line, he/she may only have 10 minutes to use the mobile device. The proposed prioritizing system can sort all mobile device applications in an order based on usage duration history such that the application with the shortest average usage duration is listed first, and the longest average usage duration is listed last. This helps the user make a reasonable decision on which application to use, based on the time available. Optionally, the average usage duration can be displayed when the user selects a specific application. The available time for using the phone can be determined by the information in the user's calendar. For instance, if User A has a meeting in 15 minutes and is on his/her mobile device, activities that fit that time period will be displayed first.

C. User's social network online status:
If user A knows user B is online on an IM service, user A may want to chat with user B instead of checking email.

D. User's friend's activity:
If user A is waiting to board an airplane, when he/she wants to use the mobile device, and notices one of his friends is playing an online game, he may decide to play the game with his friend instead of checking email.

In an embodiment of the present invention, prioritizing focuses on the following aspects:

A) A particular timeframe or the timeframe available to the user:
For example, between 3 pm and 3:30 pm is a regular timeframe for picking up his kids, or 8:30 am-9:00 am is a regular time in which the user is in morning traffic.

B) Time and Task:
The mobile device applications can be prioritized based on the user's usage history patterns, such as the time the user usually spends on an application, and/or the time the user currently has available to use the mobile device. The user's calendar, history patterns, location and network history can be used to estimate the user's time limit on the mobile device.
For example, if every weekday around 3:00 PM the user's calendar is blocked for 30 minutes and for 10 of those minutes the user is usually on their mobile device using a 3G network, and in their car (location based info). This history can be known so that when the user goes on their phone somewhere around 3 PM with the same pattern, the phone knows the usage will most likely be for only 10 minutes. The applications can then be prioritized based on which ones can be successfully used within a 10 minute timeframe, based on the pattern of the user's time for each application.

C) Other activities affecting the priority order:
Other things that can be taken into consideration include applications that need the user's immediate attention, the user's social network updates, and the user's contacts' current activities. Also, criteria can be whether any application needs an update and the urgency of the application updates, battery usage (such as, wireless usage consumes more battery power), and the user's settings of network preference (such as if the wireless is 3G network instead of wifi).

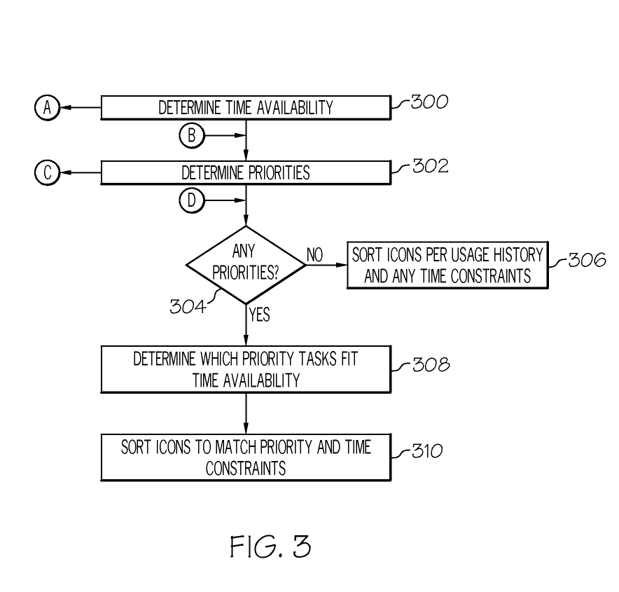

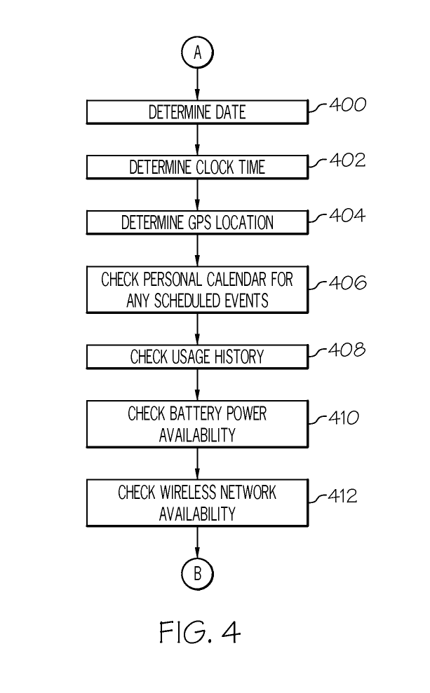

Referring now to FIGS. 3, 4, and 5, flow diagrams further illustrate an embodiment of the present invention. In FIG. 3 at block 300, the user's system determines how much time is available to the user. Referring to FIG. 4, a flowchart illustrates one embodiment of how this determination is made. At block 400, the system determines the date, for example, Tuesday Mar. 23, 2011. At block 402, the system determines the clock time, for example, 3:00 PM EST. At block 404, the user's current location is determined by, for example, GPS.

The system then checks the user's calendar at block 406 for any scheduled events. For example, if the user has a meeting scheduled for 3:30 PM EST and the current time is 3:00 PM EST, the present invention may determine there are 30 minutes for use of the mobile device, and the application icons are prioritized and arranged accordingly.

At block 408, the system checks usage history. As previously mentioned above, if, for example, the user is waiting in a school car pool line at the same time every day, the system can check the history of what the user has actually done before and can prioritize the application icons accordingly.

At block 410, the system checks battery power availability. If there is insufficient power to accomplish time consuming or high power usage tasks, the system can place those tasks in a lower priority position.

The system then checks for the availability of a wireless network (Wi-Fi, 3G, etc.) at block 412. This is particularly useful with programs that require more network data transmission time than is currently available. In addition, if the user's network time is close to exceeding their contracted monthly allowance, the user may decide to change the criteria for allowing such use. The present invention then returns through B to FIG. 3.

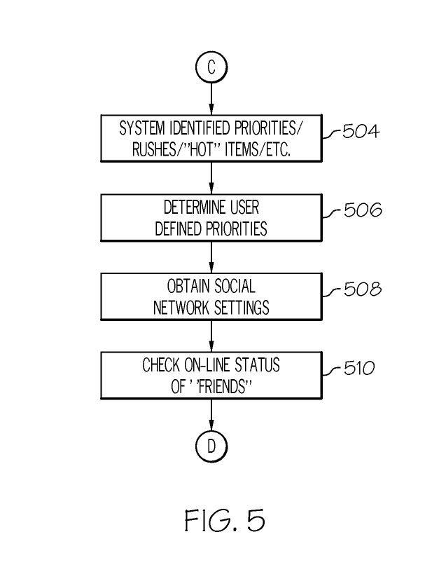

In FIG. 3, at block 302, priorities are determined. Referring to FIG. 5, a flowchart illustrates one embodiment of how this determination is made. The present invention may first identify any system defined priorities at block 504. System defined priorities may include email or SMS that is indicated as ‘urgent,’ ‘rush,’ ‘hot,’ etc. These items may be adjusted by the user, if so desired.

At block 506, user defined priorities, if any, are determined. This can be any altered system defined priorities or any user added preference items. Preference items could be, for example, a listing of stock prices, movies at the user's favorite theater, and etc.

At block 508, the user's social network settings may be checked and/or updated. At block 510, the user's contacts' online activities may be checked. As previously stated above, blocks 508 and 510 may include determinations of whether a certain other user is online on an IM service, then the user may want to chat instead of checking email. Also, if the user is waiting to board an airplane, when he/she wants to use the mobile device, if one of his friends is playing an online game, he may decide to play the game with his friend instead of checking email. The present invention then returns to FIG. 3 through D.

It is then determined at decision block 304 of FIG. 3, whether there are any priorities. If the response to decision block 304 is no, the present invention flows to block 306. At block 306, the icons representing applications are arranged per user's usage history and any time constraints, if applicable.

If the response to decision block 304 is yes, it is determined at block 308 which priority tasks fit the time availability. At block 310, the application icons are prioritized to match priority and time constraints and are displayed accordingly on the user's mobile device.

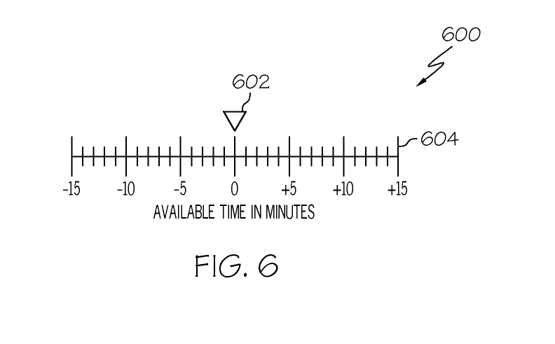

Referring to FIG. 6, one embodiment of a user adjustable time control 600 is illustrated. An adjustable slider 602 can be provided on a user's mobile device, either automatically or upon user selection. As shown, the slider can be used to increase or decrease the time available from minus fifteen minutes to plus fifteen minutes along a timeline 604. This would provide the user with an adjustment, for example, when the time available is determined to be five minutes before a meeting, but the user knows another attendee is going to be late, the user may manually adjust the time available to ten minutes. Although not shown, other such controls could comprise a clock face, a rotary selector, and etc.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of prioritizing and displaying application launching icons on a mobile electronic device having a limited display area, comprising:
using a processor to identify how much time is available to a user for use of the device;
using the processor to identify any tasks that correspond to defined priorities;
when it is determined that there are no defined priorities, displaying the application launching icons in accordance with said how much time and a usage history of the user in order to provide the user with a prioritized arrangement of the applications as represented by the icons in order to accomplish tasks; and
when it is determined that there are defined priorities, displaying the application launching icons in accordance with said how much time and said defined priorities in order to provide the user with a prioritized arrangement of the applications as represented by the icons in order to accomplish priority tasks.

2. The method of claim 1, wherein using the processor to identify any tasks that correspond to defined priorities comprises checking for system defined priorities.

3. The method of claim 1, wherein using the processor to identify any tasks that correspond to defined priorities comprises checking for user defined priorities.

4. The method of claim 3, further comprising dynamically changing said prioritized arrangement upon occurrence of a predefined event.

5. The method of claim 3, further comprising dynamically changing said prioritized arrangement upon occurrence of a user initiated command.

6. The method of claim 1, further comprising setting the available time with a user adjustable control.

7. The method of claim 1, wherein using the processor to identify how much time is available comprises at least one of:
determining a calendar date, a clock time, and a GPS location;
checking a personal electronic calendar for any scheduled events;
checking how much time the user has previously used based on usage history;
checking the mobile device's battery status; and
checking for availability of a wireless network.

8. A system for prioritizing and displaying application launching icons on a mobile electronic device having a limited display area, comprising:
a processor; and
memory connected to the processor, wherein the memory is encoded with instructions and wherein the instructions when executed comprise:
instructions for identifying how much time is available to a user for use of the device;
instructions for identifying any tasks that correspond to defined priorities;
when it is determined that there are no defined priorities, instructions for displaying the application launching icons in accordance with said how much time and a usage history of the user in order to provide the user with a prioritized arrangement of the applications as represented by the icons in order to accomplish tasks; and
when it is determined that there are defined priorities, instructions for displaying the application launching icons in accordance with said how much time and said defined priorities in order to provide the user with a prioritized arrangement of the applications as represented by the icons in order to accomplish priority tasks.

9. The system of claim 8, wherein instructions for identifying any tasks that correspond to defined priorities comprises instructions for checking for system defined priorities.

10. The system of claim 8, wherein instructions for identifying any tasks that correspond to defined priorities comprises instructions for checking for user defined priorities.

11. The system of claim 10, further comprising instructions for dynamically changing said prioritized arrangement upon occurrence of a predefined event.

12. The system of claim 10, further comprising instructions for dynamically changing said prioritized arrangement upon occurrence of a user initiated command.

13. The system of claim 8, further comprising instructions for setting the available time with a user adjustable control.

14. The system of claim 8, wherein the instructions for identifying how much time is available comprises at least one of:
instructions for determining a calendar date, a clock time, and a GPS location;
instructions for checking a personal electronic calendar for any scheduled events;
instructions for checking how much time the user has previously used based on usage history;
instructions for checking the mobile device's battery status; and
instructions for checking for availability of a wireless network.

15. A computer program product for prioritizing and displaying application launching icons on a mobile electronic device having a limited display area, the computer program product comprising a computer readable storage medium having computer readable program code embodied therewith, the computer readable program code comprising:
computer readable program code configured to identify how much time is available to a user for use of the device;
computer readable program code configured to identify any tasks that correspond to defined priorities;
when it is determined that there are no defined priorities, computer readable program code configured to display the application launching icons in accordance with said how much time and a usage history of the user in order to provide the user with a prioritized arrangement of the applications as represented by the icons in order to accomplish tasks; and
when it is determined that there are defined priorities, computer readable program code configured to display the application launching icons in accordance with said how much time and said defined priorities in order to provide the user with a prioritized arrangement of the applications as represented by the icons in order to accomplish priority tasks.

16. The computer program product of claim 15, wherein computer readable program code configured to identify any tasks that correspond to defined priorities comprises computer readable program code configured to check for system defined priorities.

17. The computer program product of claim 15, wherein computer readable program code configured to identify any tasks that correspond to defined priorities comprises computer readable program code configured to check for user defined priorities.

18. The system of claim 17, further comprising computer readable program code configured to dynamically change said prioritized arrangement upon occurrence of a predefined event.

19. The system of claim 17, further comprising computer readable program code configured to dynamically change said prioritized arrangement upon occurrence of a user initiated command.

20. The computer program product of claim 15, further comprising computer readable program code configured to set the available time with a user adjustable control.
